(19) United States
(12) Patent Application Publication
(10) Pub. No.: US 2009/0157848 A1
(43) Pub. Date: Jun. 18, 2009

(54) APPLICATION SERVER PROCESSING TCP/IP REQUESTS FROM A CLIENT BY INVOKING AN ASYNCHRONOUS FUNCTION

(75) Inventor: Thau Soon Khoo, Selangor (MY)

Correspondence Address: WESTERN DIGITAL TECHNOLOGIES, INC.;ATTN: LESLEY NING, 20511 LAKE FOREST DR., E-118G, LAKE FOREST, CA, 92630, US

(73) Assignee: Western Digital Technologies, Inc., Lake Forest, CA (US)

(21) Appl. No.: 11/959,172

(22) Filed: Dec. 18, 2007

(51) Int. Cl. G06F 15/16

(52) U.S. Cl. 709/219

(57) ABSTRACT

An application server is disclosed for communicating with a plurality of clients. The application server executes code segments stored on a computer readable storage medium, such as on a disk storage medium, FLASH memory, etc. The application server initiates a Transmission Control Protocol/Internet Protocol (TCP/IP) object for processing a request received from one of the clients, wherein the request comprises input data. The application server invokes an asynchronous function with the TCP/IP object as an input parameter to process the request, and when the asynchronous function is finished processing the request, returns output data to the client.

### BACKGROUND

Network systems such as the Internet have employed asynchronous communication between client computers and an application server in order to increase throughput and overall performance. With asynchronous communication, the application server releases resources associated with a port (e.g., a TCP/IP port) as soon as a request is received by one of the client computers, thereby freeing the port to process other requests from other client computers. When the application server is finished processing a request, a facility is provided to return a response to the corresponding client computer.

Web Services (WS) is an industry wide standard for implementing client/server communication over a network, including asynchronous communication. However, WS is implemented using the Hypertext Transfer Protocol (HTTP) which has significant overhead in the protocol layers that can reduce the throughput of the communication sessions. In addition, the WS code itself typically has significant overhead in the form of services that may not be required for a particular client/server configuration.

### BRIEF DESCRIPTION OF THE DRAWINGS

FIG. 1 shows an application server according to an embodiment of the present invention for asynchronously processing requests received from a plurality of clients.

FIG. 2A is a flow diagram according to an embodiment of the present invention wherein one of the clients initiates a TcpClient to send a request to the application server.

FIG. 2B is a flow diagram according to an embodiment of the present invention wherein the application server processes the requests asynchronously by invoking an asynchronous function.

FIG. 2C is a flow diagram according to an embodiment of the present invention wherein a SyncLock call ensures that multiple threads do not execute the same statements at the same time.

FIG. 3A is source code according to an embodiment of the present invention for implementing the flow diagram of FIG. 2A.

FIG. 3B-3G is source code according to an embodiment of the present invention for implementing the flow diagram of FIG. 2C.

FIG. 4 shows an embodiment of the present invention wherein the clients comprise a plurality of disk drive manufacture stations.

FIG. 5 is a flow diagram according to an embodiment of the present invention wherein one of the disk drive manufacture station sends a request to the application server to receive parameters for executing a TPI calibration procedure.

### DETAILED DESCRIPTION OF EMBODIMENTS OF THE INVENTION

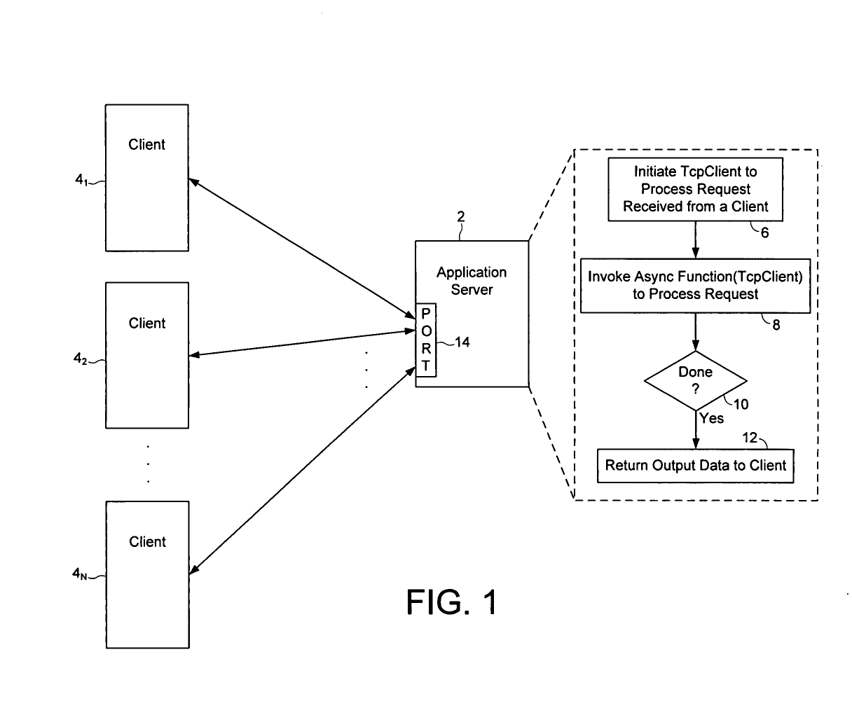

FIG. 1 shows an application server 2 for communicating with a plurality of clients 4₁-4_{N}. The application server 2 executes code segments stored on a computer readable storage medium, such as on a disk storage medium, FLASH memory, etc. The application server 2 executes the flow diagram shown in FIG. 1 by initiating a Transmission Control Protocol/Internet Protocol (TCP/IP) object for processing a request received from one of the clients (step 6), wherein the request comprises input data. The application server invokes an asynchronous function with the TCP/IP object as an input parameter to process the request (step 8), and when the asynchronous function is finished processing the request (step 10), returns output data to the client (step 12).

In one embodiment, the application server 2 comprises a port 14 (such as a TCP/IP port), wherein the code segments executed by the application server 2 are operable to receive a plurality of requests from the clients 4₁-4_{N} through the port 14 and concurrently process the plurality of requests. When a first request is received by the application server 2 through the port 14, an asynchronous function is initiated to process the request (step 8) and the port 14 is released (made available to receive a second request from another of the clients). In this manner, the application server 2 may be concurrently processing multiple requests while the port 14 is receiving new requests from the clients, as opposed to reserving the port 14 until a single request has been processed by the application server 2.

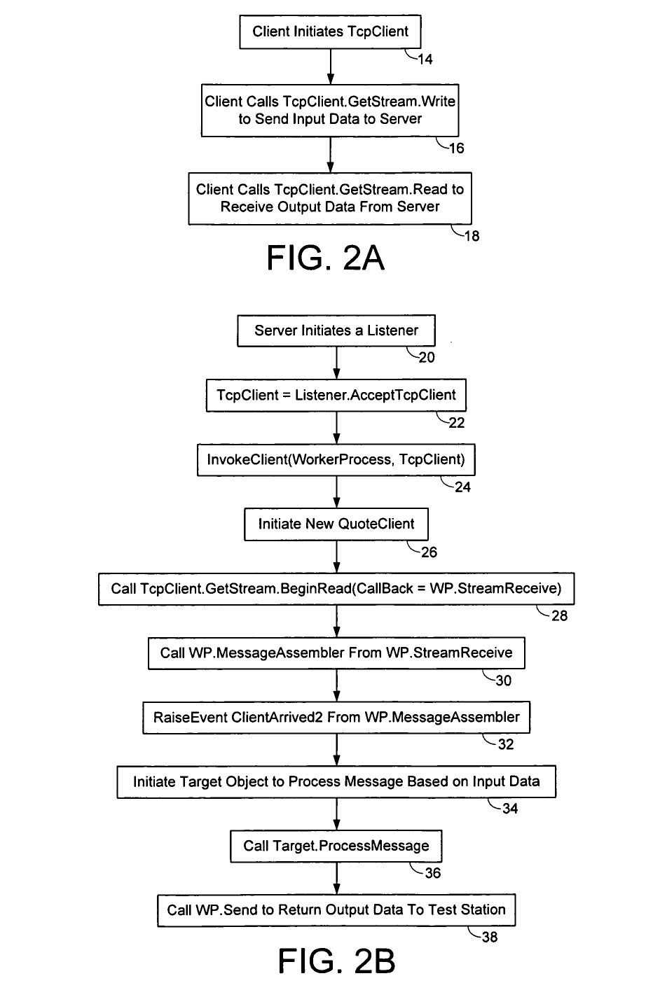

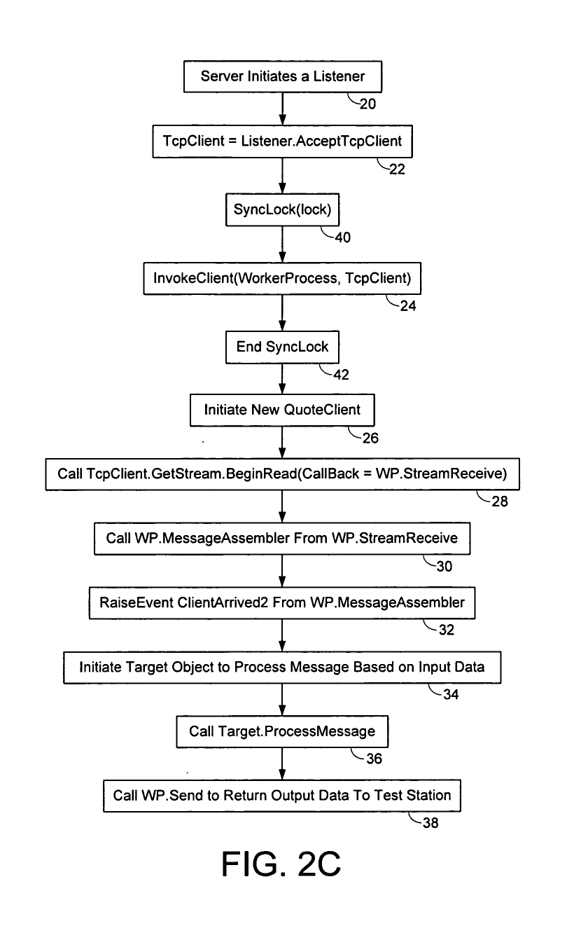

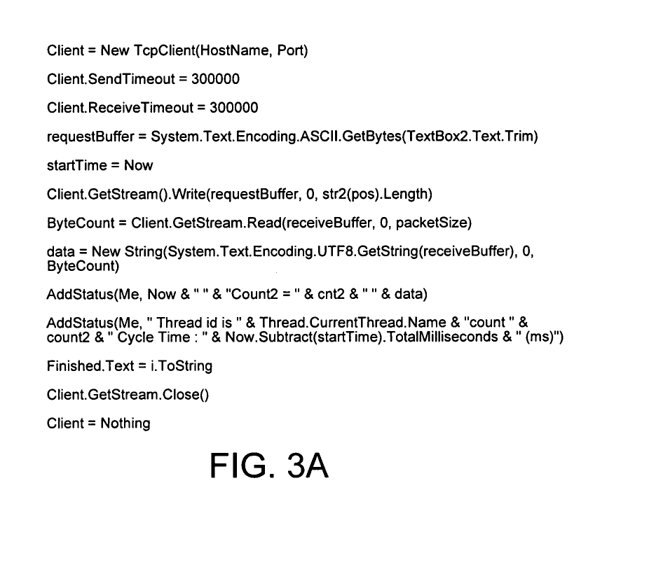

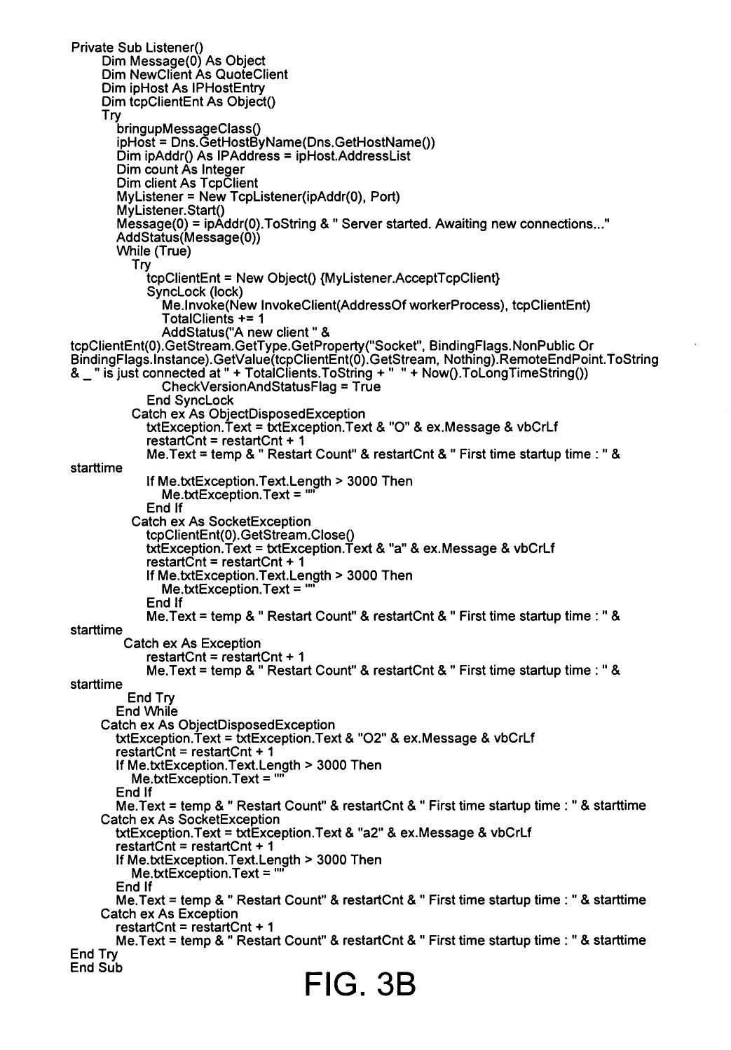

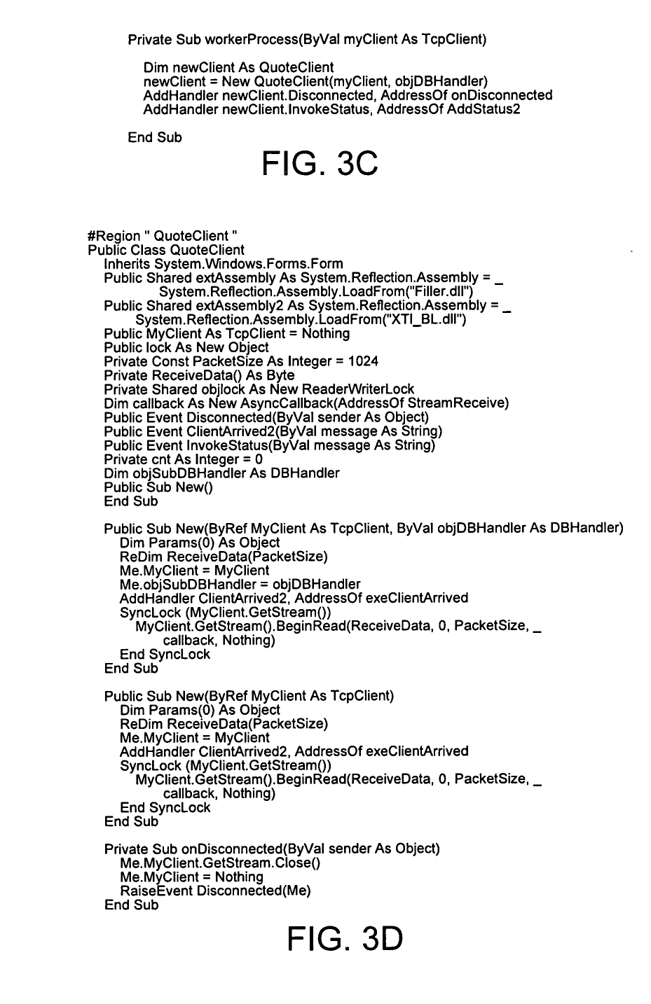

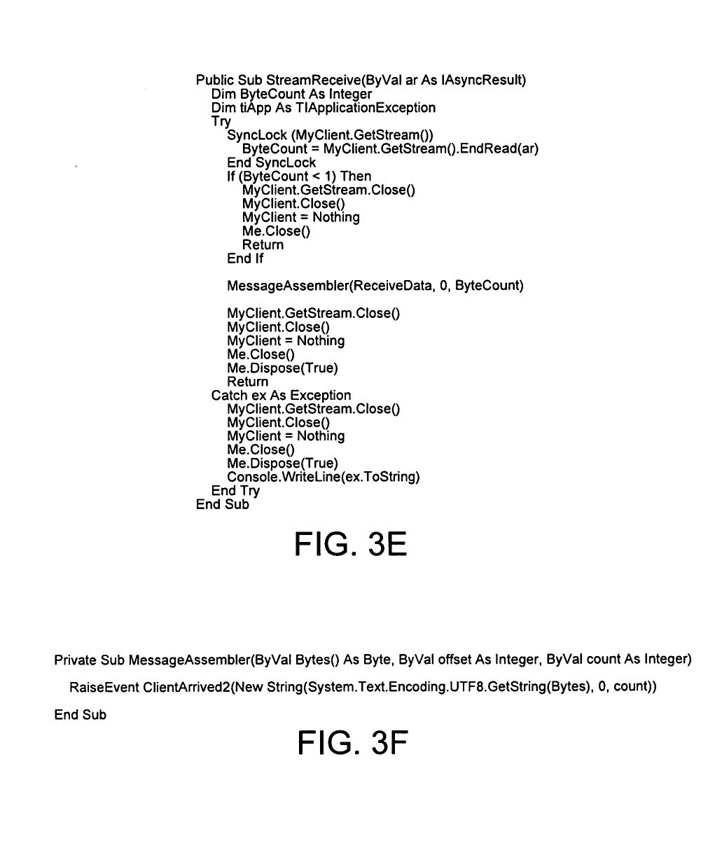

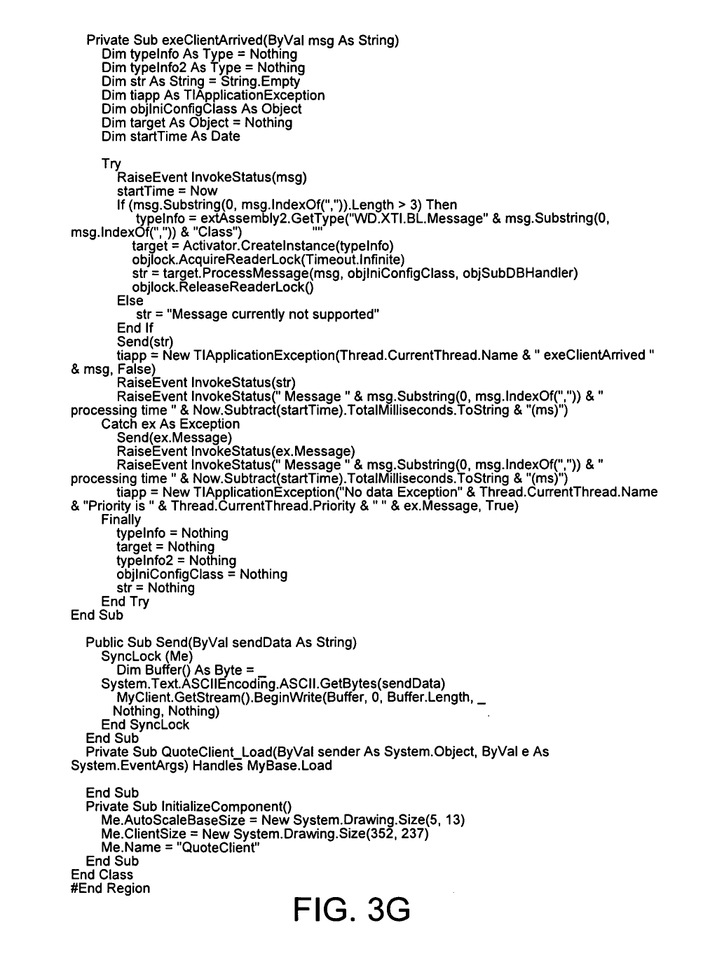

Any suitable code segments may be employed in the embodiments of the present invention. In an embodiment illustrated in the flow diagram of FIG. 2A, the client initiates a TcpClient (step 14) and calls the function TcpClient.GetStream.Write to transmit a request to the application server (step 16 shown in FIG. 3A). The object TcpClient is a Microsoft .Net class, but any suitable class may be employed. The function TcpClient.GetStream.Write is called asynchronously meaning that control returns to the client and the port is released to allow other clients to transmit requests. The client calls TcpClient.GetStream.Read (step 18) in order to receive the output data from the application server once the request has been processed.

Referring to FIG. 2B, the application server initiates a Listener object (step 20) and then assigns a TcpClient to the return of the function Listener.AcceptTcpClient (step 22 shown in FIG. 3B). The Listener object is a .Net class, but any suitable class may be employed. The function Listener.AcceptTcpClient returns a TcpClient when a request is received from one of the clients over the port 14. The application server then invokes an asynchronous function named WorkerProcess using a .Net Invoke call (FIG. 3B). The input parameter of the .Net Invoke call is a delegate (a pointer to the WorkerProcess function) and the TcpClient. The .Net Invoke call executes the WorkerProcess function in a new thread (and therefore asynchronously) with the TcpClient as an input parameter to the WorkerProcess function (FIG. 3C). Since the WorkerProcess is executed in a new thread, it is similar to an object in that all function calls made from the WorkerProcess are a part of the thread. The following description therefore refers to the WorkerProcess as a WP object even though it is not actually an instantiated object.

The WorkerProcess function (FIG. 3C) initiates a QuoteClient (step 26), wherein initiating the QuoteClient includes calling the function TcpClient.Getstream.BeginRead (step 28) which has a callback function as an input parameter (FIG. 3D). The callback function is executed after receiving the input data from the client, and in the embodiment of FIG. 3D, the callback function is the function WP.StreamReceive (FIG. 3E). The function WP.StreamReceive calls the function WP.MessageAssembler (step 30 shown in FIG. 3F) which raises an event named ClientArrived2 using the .Net RaiseEvent call (step 32), wherein ClientArrived2 is assigned to the event handler named WP.exeClientArrived (FIG. 3D). Raising an event to process the request received from the client enhances the asynchronous aspect of the present invention by essentially processing the request in the background.

In the WP.exeClientArrived function (FIG. 3G), a target object is initiated (step 34) based on the input data received from the client, and the request is processed by calling Target.ProcessMessage (step 36). The output data returned from Target.ProcessMessage is returned to the client by calling WP.Send (step 38). The function WP.Send calls the function TcpClient.GetStream( ).BeginWrite to send the output data to the client over the port 14 (FIG. 3G). When the output data is received by the client, the TcpClient.GetStream.Read function (at the client) is executed and the output data received from the application server is stored in a receiveBuffer (FIG. 3A).

In an embodiment illustrated in FIG. 2C, the application server executes a SyncLock statement (step 40 shown in FIG. 3B) to ensure that multiple threads do not execute the same statements at the same time. When the thread reaches the SyncLock statement, it evaluates the expression and maintains exclusivity until it has a lock on the object that is returned by the expression. This prevents an expression from changing values during the running of several threads, which can give unexpected results. Once the WorkerProcess function has been invoked with the new TcpClient as input, the statement End SyncLock is executed (step 42) which enables subsequent requests received from the clients to be processed without overwriting the previous TcpClient.

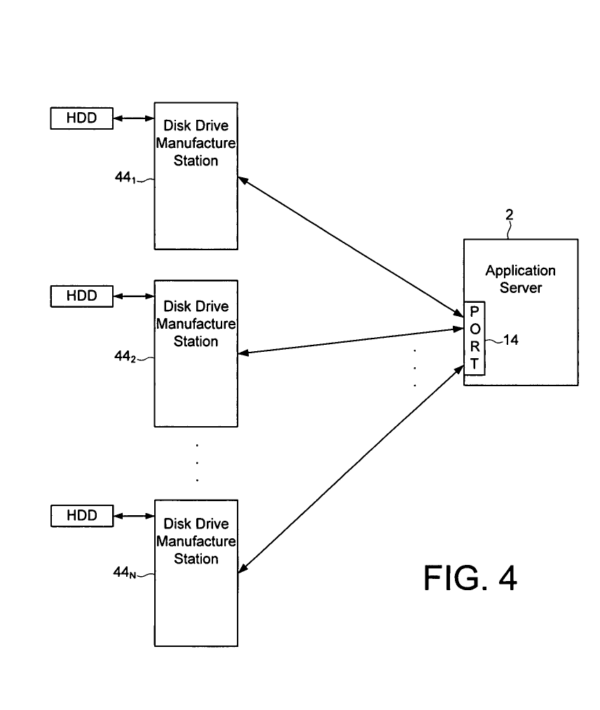

Any suitable clients communicating with an application server over any suitable network may be employed in the embodiments of the present invention. In one embodiment, the clients comprise computers communicating over the Internet with the application server. In an embodiment shown in FIG. 4, the clients comprise a plurality of disk drive manufacture stations 44₁-44_{N}, wherein each disk drive manufacture station 44₁-44_{N} interfaces with one or more hard disk drives (HDD). Each disk drive manufacture station 44₁-44_{N} may perform a suitable manufacturing process on the HDDs in an assembly line fashion. For example, one of the disk drive manufacture stations may be responsible for the component assembly of an HDD, wherein the application server maintains a central database of relevant information associated with each newly assembled HDD (e.g., model number, head disk assembly part number, etc.). Another disk drive manufacture station may be responsible for bar code scanning an assembled HDD to identify information such as vendor part numbers (disk type, head type, etc.) which is then transmitted to the application server for logging in the central database. Yet another of the disk drive manufacture stations may be responsible for programming an assembled HDD to execute certain procedures for testing (e.g., quality assurance such as particle contaminate tests performed in a clean room environment, disk imbalance testing, etc.) as well as procedures for configuring the HDD.

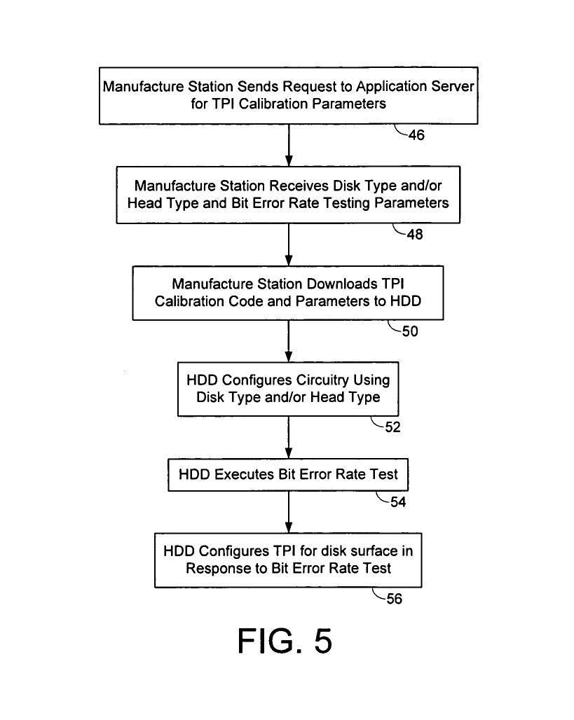

In one embodiment, a microprocessor within the HDD executes the manufacturing procedures in order to test and configure the HDD. In an example embodiment described below with reference to FIG. 5, each HDD will execute a tracks per inch (TPI) calibration procedure which will select a TPI for each disk surface in response to a bit error rate test. Before executing the TPI calibration procedure, the disk drive test station 4 will request the relevant parameters from the application server 2, such as component parameters for the HDD (e.g., disk type, head type, ect.) as well as other execution parameters, such as the number of adjacent track writes to perform before testing the bit error rate. The application server 2 provides an efficient central data base facility for storing the relevant parameters of a manufactured HDD (e.g., component parameters) and for providing this information to the disk drive manufacture stations when needed. In addition, certain changes to a particular manufacturing procedure may be made at the application server 2 which are then reflected in the information sent to each disk drive manufacture station.

FIG. 5 is a flow diagram according to an embodiment of the present invention wherein an HDD connected to a disk drive manufacture station executes a TPI calibration procedure in response to the output data received from the application server. The disk drive manufacture station sends a requests to the application server for the TPI calibration parameters (step 46), and the application server replies with at least one of a disk type and a head type within the particular HDD, as well as bit error rate testing parameters (step 48). The disk drive test station transmits the TPI calibration code and parameters received from the application server to the HDD (step 50), and the HDD configures appropriate circuitry (e.g., write current amplitude, fly height, read current bias, etc.) based on the information received from the application server (step 52). After the HDD configures the circuitry, the HDD executes a bit error rate test, for example, by writing and reading a test pattern to the disk (step 54), and in response to the bit error rate test, the HDD configures an optimal TPI for the disk surface (step 56).

Any suitable application server 2 may be employed in the embodiments of the present invention, wherein the application server 2 comprises a microprocessor for executing the flow diagrams illustrated in the above-described figures. The code segments shown in FIG. 3A-3G are exemplary code segments for implementing the flow diagrams, however, any suitable code segments may be employed. In addition, the code segments shown in FIG. 3A-3G comprises source code which is compiled into executable code segments for execution by the microprocessor of the application server. In one embodiment, the source code is compiled into the executable form on a dedicated computer, and then the executable code segments are installed onto the application server 2. Therefore, the code segments shown in FIG. 3A-3G may exist in any suitable form at the application server 2.

What is claimed is:

1. An application server for communicating with a plurality of clients, the application server operable to execute code segments stored on a computer readable storage medium, the code segments operable to:
initiate a Transmission Control Protocol/Internet Protocol (TCP/IP) object for processing a request received from one of the clients, wherein the request comprises input data; and
invoke an asynchronous function with the TCP/IP object as an input parameter.

2. The application server as recited in claim 1, further comprising a TCP/IP port, wherein the code segments are further operable to receive a plurality of requests from the clients through the port and concurrently process the plurality of requests.

3. The application server as recited in claim 1, wherein the code segments comprise .Net code segments.

4. The application server as recited in claim 3, wherein the asynchronous function is invoked using a .Net Invoke call.

5. The application server as recited in claim 1, wherein the code segments further comprise a code segment for calling a SyncLock statement prior to invoking the asynchronous function.

6. The application server as recited in claim 3, wherein:
the code segments are further operable to call a .Net BeginRead function of the TCP/IP object in order to receive the input data from the client;
a callback function is an input parameter of the .Net BeginRead function; and
the callback function is executed after receiving the input data from the client.

7. The application server as recited in claim 3, wherein the code segments are further operable to call a .Net Send function to return output data to the client.

8. The application server as recited in claim 1, wherein the clients comprise a plurality of disk drive manufacture stations.

9. The application server as recited in claim 8, wherein the disk drive manufacture stations comprises an assembly station for assembling a disk drive, and the application server returns assembly line data to the assembly station.

10. The application server as recited in claim 9, wherein the disk drive manufacture stations comprises a barcode station for generating bar code data identifying components of the assembled disk drive, and the input data comprises the bar code data.

11. The application server as recited in claim 8, wherein the input data comprises at least one of a type of disk and a type of head within a disk drive coupled to the disk drive manufacture station.

12. The application server as recited in claim 8, wherein output data returned to one of the disk drive manufacture stations comprises at least one of a type of disk and a type of head within a disk drive coupled to the disk drive manufacture station.

13. The application server as recited in claim 8, wherein output data returned to the disk drive test station comprises a testing parameter for testing an operating feature of a disk drive coupled to the disk drive manufacture station.

14. The application server as recited in claim 13, wherein:
the testing parameter comprises a parameter for testing a bit error rate of a disk drive coupled to the disk drive test station; and
a result of the bit error rate test is for configuring a tracks per inch of a disk surface within the disk drive.

15. A method of communicating information between an application server and a plurality of clients, the method comprising:
the application server initiating a Transmission Control Protocol/Internet Protocol (TCP/IP) object for processing a request received from one of the clients, wherein the request comprises input data; and
the application server invoking an asynchronous function with the TCP/IP object as an input parameter.

16. The method as recited in claim 15, further comprising the application server receiving a plurality of requests from the clients through a TCP/IP port and concurrently processing the plurality of requests.

17. The method as recited in claim 15, wherein the asynchronous function is invoked using a .Net Invoke call.

18. The method as recited in claim 15, further comprising the application server executing a SyncLock statement prior to invoking the asynchronous function.

19. The method as recited in claim 15, further comprising the application server calling a .Net BeginRead function of the TCP/IP object in order to receive the input data from the client, wherein:
a callback function is an input parameter of the .Net BeginRead function; and
the callback function is executed after receiving the input data from the client.

20. The method as recited in claim 15, further comprising the application server executing a .Net Send function to return output data to the client.

21. The method as recited in claim 15, wherein the clients comprise a plurality of disk drive manufacture stations.

22. The method as recited in claim 21, wherein the disk drive manufacture stations comprises an assembly station for assembling a disk drive, further comprising the application server returning assembly line data to the assembly station.

23. The method as recited in claim 22, wherein the disk drive manufacture stations comprises a barcode station for generating bar code data identifying components of the assembled disk drive, and the input data comprises the bar code data.

24. The method as recited in claim 21, wherein the input data comprises at least one of a type of disk and a type of head within a disk drive coupled to the disk drive manufacture station.

25. The method as recited in claim 21, wherein output data returned to one of the disk drive manufacture stations comprises at least one of a type of disk and a type of head within a disk drive coupled to the disk drive manufacture station.

26. The method as recited in claim 25, wherein output data returned to the disk drive test station comprises a testing parameter for testing an operating feature of a disk drive coupled to the disk drive manufacture station.

27. The method as recited in claim 26, further comprising:
testing a bit error rate of a disk drive coupled to the disk drive test station in response to the testing parameter; and
configuring a tracks per inch of a disk surface within the disk drive in response to the bit error rate testing.
